(19) United States
(12) Patent Application Publication
(10) Pub. No.: US 2025/0252638 A1
(43) Pub. Date: Aug. 7, 2025

(54) AVATAR CONTROL METHOD AND SYSTEM AND NON-TRANSITORY COMPUTER READABLE STORAGE MEDIUM

(71) Applicant: HTC Corporation, Taoyuan City (TW)

(72) Inventors: Sheng-Kun HUANG, Taoyuan City (TW); Min-Tse HSU, Taoyuan City (TW)

(21) Appl. No.: 18/433,319

(22) Filed: Feb. 5, 2024

(51) Int. Cl. G06T 13/40; G06F 3/01; G06V 40/10; G06V 40/20

(52) U.S. Cl. CPC G06T 13/40; G06F 3/012; G06V 40/10; G06V 40/20

(57) ABSTRACT

The present disclosure provides an avatar control method and system. The avatar control method is applicable to the avatar control system, is configured to control an avatar, which is corresponding to a user in a real-world environment, in an immersive content, and includes: detecting if the user makes a first target pose; when the user makes the first target pose, displaying a guide object in the immersive content according to a facing direction of the user; detecting if the user makes a second target pose different from the first target pose; and when the user makes the second target pose, controlling the avatar to appear at a position indicated by the guide object.

### BACKGROUND

### Field of Invention

This disclosure relates to a method and system, and in particular to an avatar control method and system.

### Description of Related Art

In some related arts of the virtual reality (VR), the user is usually restricted to experiencing the VR environment in a specific area (e.g., room, etc.), which causes some issues. For example, the user can only use at least one joystick on the VR controller to move his/her avatar in the VR environment. In other words, the user is unable to move the avatar in the VR environment in the manner as he/she moves in the real-world environment.

Due to the above issues, the related arts are difficult to provide well immersion for the user, which further results in that the user has a bad game experience. Therefore, it is important to propose a new approach for moving the avatar of the user in the VR environment.

### SUMMARY

An aspect of present disclosure relates to an avatar control method. The avatar control method is applicable to an avatar control system, is configured to control an avatar, which is corresponding to a user in a real-world environment, in an immersive content, and includes: detecting if the user makes a first target pose; when the user makes the first target pose, displaying a guide object in the immersive content according to a facing direction of the user; detecting if the user makes a second target pose different from the first target pose; and when the user makes the second target pose, controlling the avatar to appear at a position indicated by the guide object.

Another aspect of present disclosure relates to an avatar control system. The avatar control system is configured to control an avatar, which is corresponding to a user in a real-world environment, in an immersive content, and includes a sensor and a processor. The sensor is configured to generate sense data. The processor is coupled to the sensor, and is configured to: detect if the user makes a first target pose based on the sense data; when the user makes the first target pose, display a guide object in the immersive content according to a facing direction of the user by controlling a display; detect if the user makes a second target pose different from the first target pose based on the sense data; and when the user makes the second target pose, control the avatar to appear at a position indicated by the guide object by controlling the display.

Another aspect of present disclosure relates to a non-transitory computer readable storage medium with a computer program to execute an avatar control method, wherein the avatar control method is applicable to an avatar control system, is configured to control an avatar, which is corresponding to a user in a real-world environment, in an immersive content, and includes: detecting if the user makes a first target pose; when the user makes the first target pose, displaying a guide object in the immersive content according to a facing direction of the user; detecting if the user makes a second target pose different from the first target pose; and when the user makes the second target pose, controlling the avatar to appear at a position indicated by the guide object.

It is to be understood that both the foregoing general description and the following detailed description are by examples, and are intended to provide further explanation of the invention as claimed.

### BRIEF DESCRIPTION OF THE DRAWINGS

The present disclosure can be more fully understood by reading the following detailed description of the embodiment, with reference made to the accompanying drawings as follows:

FIG. 1 is a block diagram of an avatar control system in accordance with some embodiments of the present disclosure;

FIG. 2 is a schematic diagram of a wearable device operated by a user in a real-world environment in accordance with some embodiments of the present disclosure;

FIGS. 3A and 3B are flow diagrams of an avatar control method in accordance with some embodiments of the present disclosure;

FIGS. 4A and 4B are schematic diagrams of a first target pose in accordance with some embodiments of the present disclosure;

FIG. 5 is a schematic diagram of an immersive content in accordance with some embodiments of the present disclosure;

FIGS. 6A and 6B are schematic diagrams of a second target pose in accordance with some embodiments of the present disclosure; and

FIG. 7 is a schematic diagram of the immersive content in accordance with some embodiments of the present disclosure.

### DETAILED DESCRIPTION

The embodiments are described in detail below with reference to the appended drawings to better understand the aspects of the present application. However, the provided embodiments are not intended to limit the scope of the disclosure, and the description of the structural operation is not intended to limit the order in which they are performed. Any device that has been recombined by components and produces an equivalent function is within the scope covered by the disclosure.

As used herein, “coupled” and “connected” may be used to indicate that two or more elements physical or electrical contact with each other directly or indirectly, and may also be used to indicate that two or more elements cooperate or interact with each other.

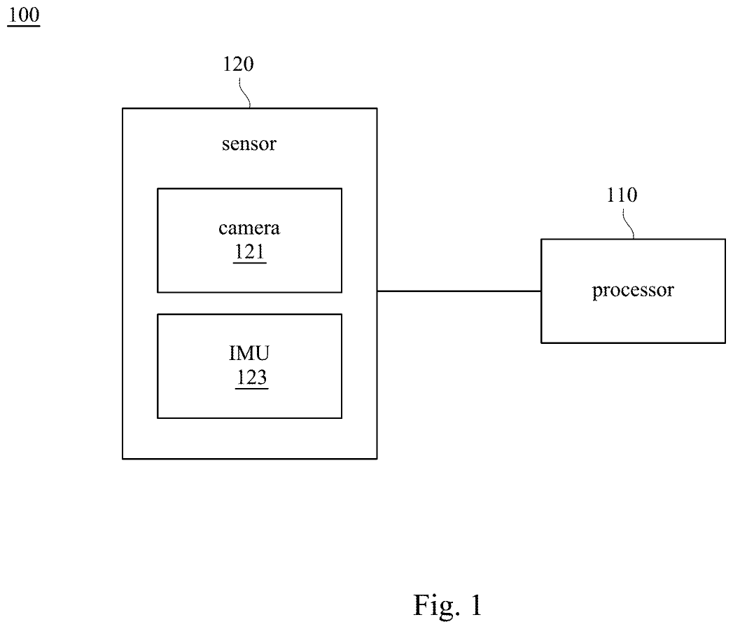

Referring to FIG. 1, FIG. 1 is a block diagram of an avatar control system 100 in accordance with some embodiments of the present disclosure. In some embodiments, the avatar control system 100 includes a processor 110 and a sensor 120. As shown in FIG. 1, the processor 110 is electrically and/or communicatively coupled to the sensor 120.

In some embodiments, the processor 110 is configured to process signals, data and/or information required by the operation of the avatar control system 100. In particular, the processor 110 can be implemented by a central processing unit (CPU), an application-specific integrated circuit (ASIC), a microprocessor, a system on a Chip (SoC) or other suitable processing circuits.

In some embodiments, the sensor 120 is configured to sense signals, data and/or information required by the operation of the avatar control system 100. In particular, as shown in FIG. 1, the sensor 120 may include at least one camera 121 and at least one inertial measurement unit (IMU) 123. The camera 121 can be implemented by at least one lens unit, a photosensitive element (i.e., image sensor such as complementary metal oxide semiconductor (CMOS), charge coupled device (CCD), etc.) and an image processor. The inertial measurement unit 123 can be implemented by an accelerometer, a gyroscope, a magnetometer, etc.

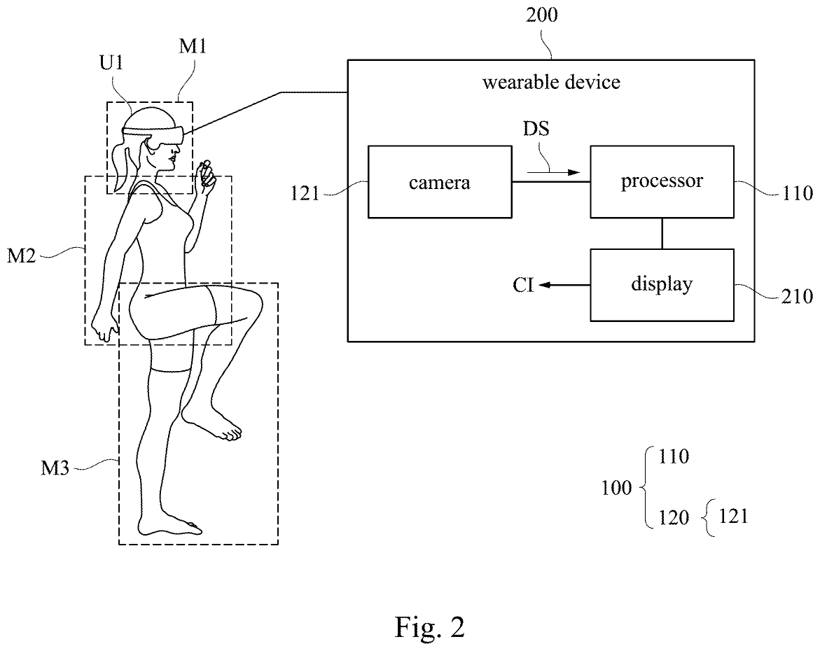

It should be understood that the sensor 120 of the present disclosure is not limited to the structure as shown in FIG. 1. For example, in some embodiments, the sensor 120 includes one of the camera 121 and the inertial measurement unit 123, which would be further described in detail with reference to FIG. 2.

Referring to FIG. 2, FIG. 2 is a schematic diagram of a wearable device 200 operated by a user U1 in a real-world environment (e.g., a room, etc.) in accordance with some embodiments of the present disclosure. As shown in FIG. 2, the wearable device 200 includes the avatar control system 100 and a display 210, and the display 210 is electrically coupled to the processor 110. In other words, the avatar control system 100 may be applied or integrated to the wearable device 200. In accordance with above descriptions of the sensor 120 of the avatar control system 100, the sensor 120 includes the camera 121 without the inertial measurement unit 123 in the embodiments of FIG. 2.

It should be understood that the integration of the avatar control system 100 and the wearable device 200 is not limited to the configuration in FIG. 2. For example, in some embodiments, the processor 110 can be independent from the wearable device 200, and can wirelessly communicate with another processor (not shown) inherent in the wearable device 200 to further communicate with the camera 121 and the display 210. Also, in some embodiments, the camera 121 can be independent from the wearable device 200, and can wirelessly communicate with the processor 110 in the wearable device 200.

In addition, the avatar control system 100 of the present disclosure is not limited to the structure as shown in FIG. 1 or 2. For example, in some embodiments, the display 210 in FIG. 2 can be included by the avatar control system 100.

In some embodiments, as shown in FIG. 2, the wearable device 200 can be a head-mounted device (HMD), and can be mounted on the head of the user U1. When the user U1 wears the wearable device 200, the wearable device 200 can provide an immersive content CI for the user U1 through the display 210. In particular, the display 210 can be implemented by an active matrix organic light emitting diode (AMOLED) display, organic light emitting diode (OLED) display, or other suitable displays.

In some embodiments, the wearable device 200 may occlude the direct visibility of the user U1 to the real-world environment. In this case, the immersive content CI can be a virtual reality (VR) environment, or a mixed reality (MR) environment. In particular, the VR environment may include at least one VR object, and both the VR environment and the VR object therein cannot be directly seen in the real-world environment by the user U1. The MR environment simulates the real-world environment and enables an interaction of the at least one VR object with the simulated real-world environment. However, the present disclosure is not limited herein. For example, the immersive content CI can be the simulated physical environment without other VR objects, which is also known as a pass-through view.

In some embodiments, the wearable device 200 does not occlude the direct visibility of the user U1 to the real-world environment. In this case, the immersive content CI can be an augmented reality (AR) environment. In particular, the AR environment augments the real-world environment directly seen by the user with the at least one VR object.

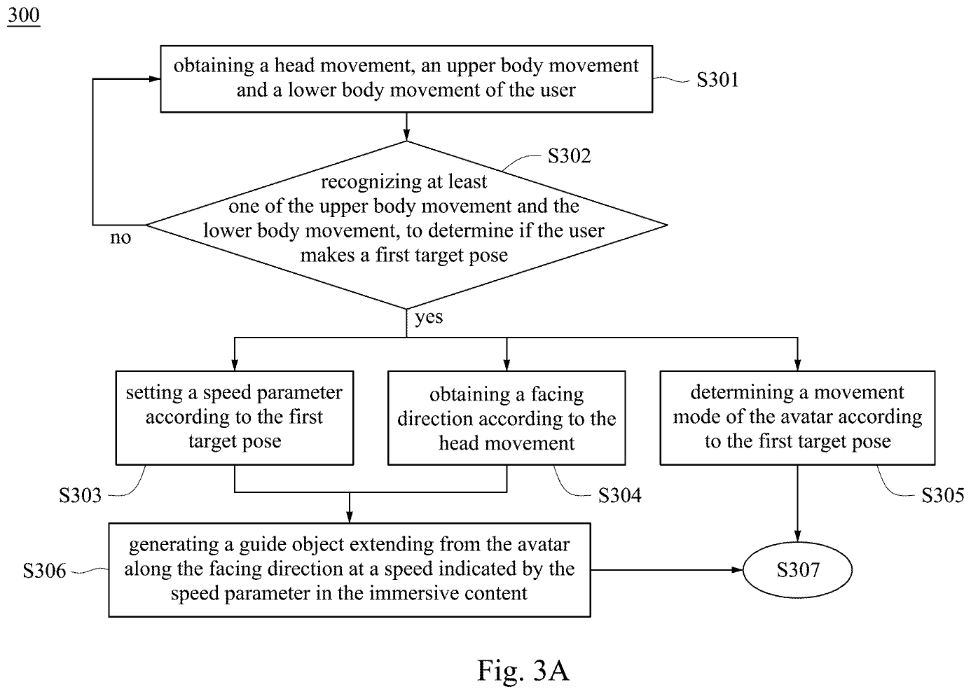

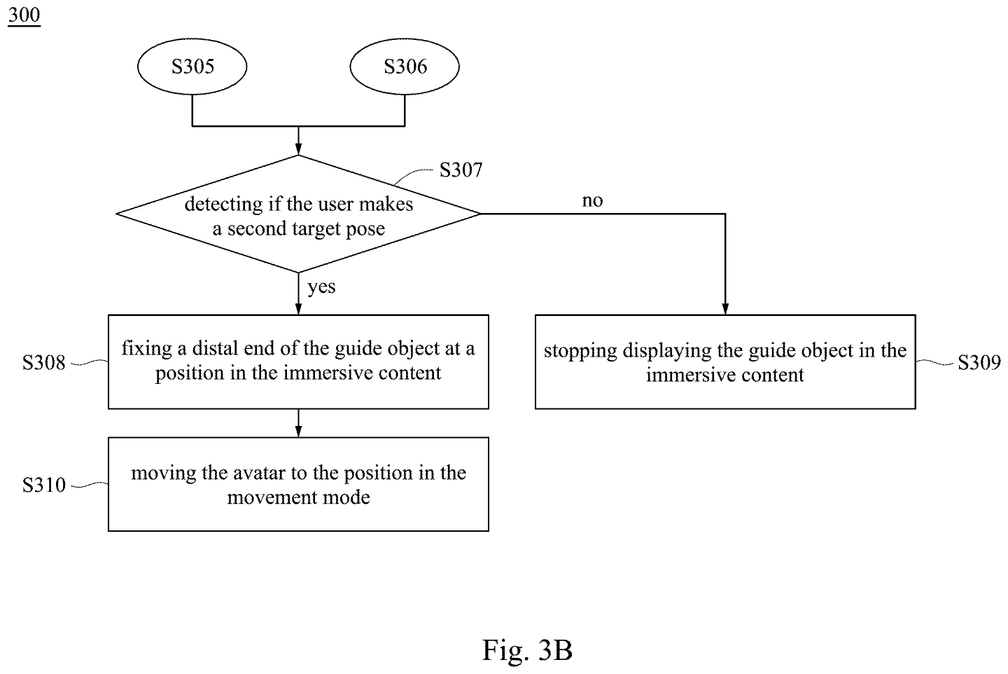

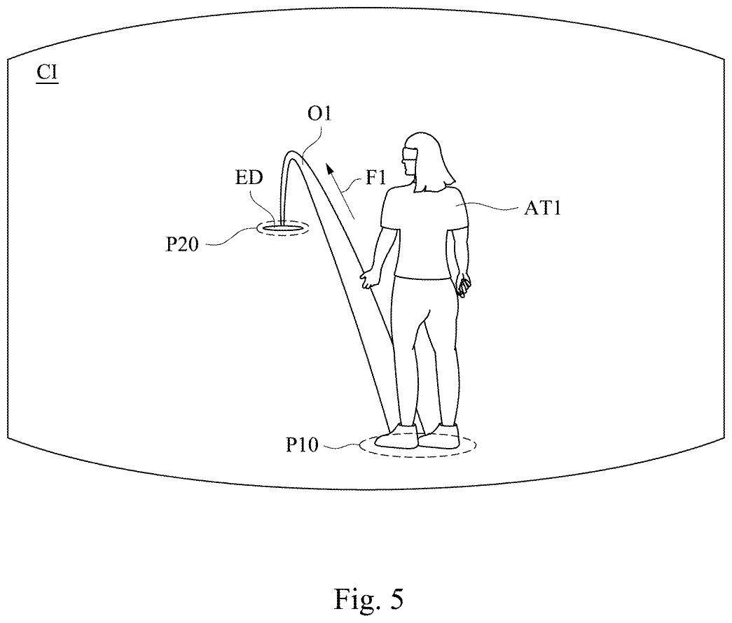

In the above embodiments, by the avatar control system 100, the user U1 wearing the wearable device 200 can make dynamic and/or static pose intuitively to control certain VR object (e.g., an avatar AT1 representing the user U1 as shown in FIG. 5, a virtual display screen, etc.) in the immersive content CI, which would be described in detail later with reference to an avatar control method 300 as shown in FIGS. 3A-3B.

Referring to FIGS. 3A and 3B, FIGS. 3A and 3B are flow diagrams of the avatar control method 300 in accordance with some embodiments of the present disclosure. In some embodiments, as shown in FIGS. 3A and 3B, the avatar control method 300 can be performed by the avatar control system 100 of FIG. 1 or 2, and includes operations S301-S310. However, the present disclosure should not be limited thereto.

Referring to FIGS. 2 and 3A together, in operation S301, the avatar control system 100 obtains a head movement M1, an upper body movement M2 and a lower body movement M3 of the user U1. In the embodiments of FIG. 2, the camera 121 disposed on the wearable device 200 captures image data (e.g., head image, upper body image, lower body image, whole body image, etc.) of the user U1, and provides the image data of the user U1 as sense data DS to the processor 110. The processor 110 may obtain the head movement M1, the upper body movement M2 and the lower body movement M3 of the user U1 by using inside-out tracking algorithms to analyze the sense data DS.

It should be understood that the embodiments of operation S301 is not limited to above descriptions. For example, in some embodiments of operation S301, the camera 121 which is independent from the wearable device 200 may also provide the image data of the user U1 as the sense data DS to the processor 110. The processor 110 may obtain the head movement M1, the upper body movement M2 and the lower body movement M3 of the user U1 by using outside-in tracking algorithms to analyze the sense data DS. Also, in some embodiments, the processor 110 may input the sense data DS generated by the camera 121 into a well-trained neural network model (e.g., AlphaPose, MMPose, ViTPose, etc.), so that the neural network model outputs the head movement M1, the upper body movement M2 and the lower body movement M3 of the user U1.

Furthermore, the sense data DS is not limited to being generated by the camera 121. For example, in some embodiments that the sensor 120 includes the inertial measurement unit 123 without the camera 121, the inertial measurement unit 123 may be arranged on the head (or on the HMD mounted on the head of the user U1), the upper body and the lower body of the user U1, and may generate and provide motion data of the head, the upper body and the lower body of the user U1 as the sense data DS to the processor 110. The processor 110 may obtain the head movement M1, the upper body movement M2 and the lower body movement M3 of the user U1 by analyzing the sense data DS.

Also, in some embodiments that the sensor 120 includes both the camera 121 and the inertial measurement unit 123, the sense data DS provided by the sensor 120 may include the image data generated by the camera 121 and the motion data generated by the inertial measurement unit 123.

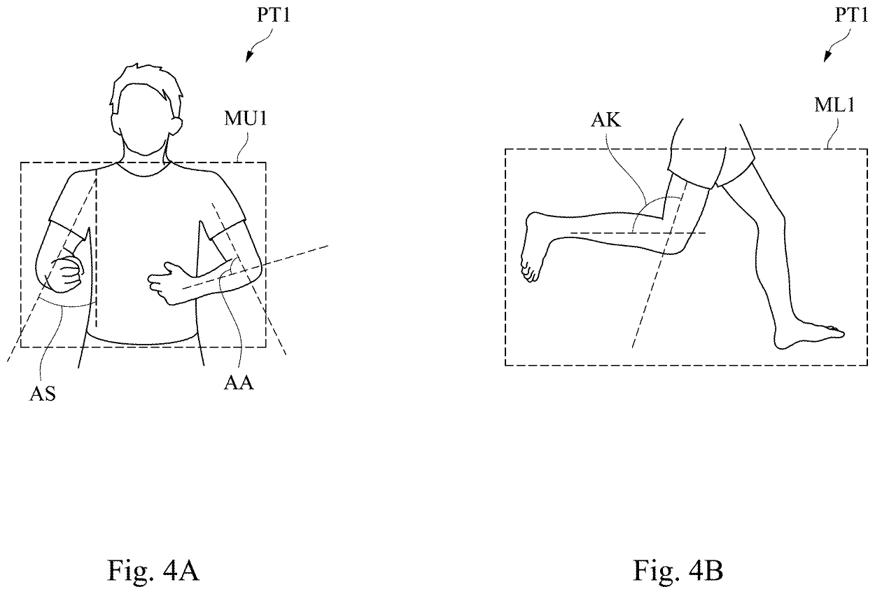

In operation S302, the processor 110 recognizes at least one of the upper body movement M2 and the lower body movement M3, to determine if the user U1 makes a first target pose PT1. In particular, the processor 110 may use pose recognize algorithms to analyze at least one of the upper body movement M2 and the lower body movement M3. Referring to FIGS. 4A and 4B, FIGS. 4A and 4B are schematic diagrams of the first target pose PT1 in accordance with some embodiments of the present disclosure.

In some embodiments of operation S302, the processor 110 recognizes that the upper body movement M2 of the user U1 is substantially the same as a preset upper body movement MU1 as shown in FIG. 4A. In this case, the processor 110 determines that the user U1 makes the first target pose PT1. In particular, the preset upper body movement MU1 may be the arm movement of the person who is running in place, and may be defined by some arm characteristics such as, an angle AS between the upper arm and the trunk less than 45 degrees, an angle AA between the upper arm and the lower arm ranging from 45 to 135 degrees, one arm moving forward and up and the other arm moving backward and down, etc. Furthermore, the preset upper body movement MU1 can be dynamic or static. That is to say, either the user U1 swings or fixes the arms, the processor 101 would recognize that the upper body movement M2 of the user U1 is substantially the same as the preset upper body movement MU1 as long as the upper body movement M2 of the user U1 satisfies the aforementioned arm characteristics.

In some embodiments of operation S302, the processor 110 recognizes that the lower body movement M3 of the user U1 is substantially the same as a preset lower body movement ML1 as shown in FIG. 4B. In this case, the processor 110 determines that the user U1 makes the first target pose PT1. In particular, the preset lower body movement ML1 may be the leg movement of the person who is running in place, and may be defined by some leg characteristics such as, an angle AK between the thigh and the calf of the leg being lifting greater than 30 degrees, one of the legs is lifting, etc. Furthermore, the preset lower body movement ML1 can be dynamic or static. That is to say, either the user U1 swings or fixes the legs, the processor 101 would recognize that the lower body movement M3 of the user U1 is substantially the same as the preset lower body movement ML1 as long as the lower body movement M3 of the user U1 satisfies the aforementioned leg characteristics.

In some embodiments of operation S302, the processor 110 determines that the user U1 makes the first target pose PT1 when the processor 110 recognizes that the upper body movement M2 and the lower body movement M3 of the user U1 are substantially the same as the preset upper body movement MU1 and the preset lower body movement ML1, respectively.

In some embodiments of operation S302, the preset upper body movement MU1 and the preset lower body movement ML1 may be the arm movement and the leg movement of the person who is stepping in place, respectively. In this case, the preset lower body movement ML1 may be defined by some leg characteristics such as, the angle AK between the thigh and the calf of the leg being lifting less than 30 degrees, one of the legs is lifting, etc. In addition, because the preset upper body movement MU1 may also be defined by the aforementioned arm characteristics, the descriptions thereof are omitted herein.

As can be seen from the above embodiments of operation S302, the first target pose PT1 can be a half-body dynamic moving pose, a half-body static moving pose, a whole-body dynamic moving pose, a whole-body static moving pose, etc. Furthermore, the moving pose may be running pose, stepping pose, etc. It should be understood that the user U1 who makes the moving pose in place will not significantly move forward.

Also, as can be seen from above descriptions of operation S301 and operation S302, in some embodiments, the processor 110 detects if the user U1 makes the first target pose PT1 based on the sense data DS generated by the sensor 120. In the embodiments of FIG. 3A, when the processor 110 detects that the user U1 does not make the first target pose PT1, operation S301 is executed again. Also, when the processor 110 detects that the user U1 makes the first target pose PT1, operation S303, operation S304 and operation S305 are executed.

In operation S303, the processor 110 sets a speed parameter according to the first target pose PT1. In some embodiments, when the first target pose PT1 made by the user U1 is the half-body moving pose, the speed parameter is set to be “+1” by the processor 110. Also, when the first target pose PT1 made by the user U1 is the whole-body moving pose, the speed parameter is set to be “+2” by the processor 110.

In operation S304, the processor 110 obtains a facing direction F1 (which is shown in FIG. 5) according to the head movement M1. In some embodiments, the facing direction F1 is inherent in the head movement M1 obtained by the processor 110 analyzing the sense data DS. Accordingly, the processor 110 can further analyze the head movement M1 to obtain the facing direction F1. In particular, the facing direction F1 may be a direction in which the user U1 is facing when the sensor 120 is sensing.

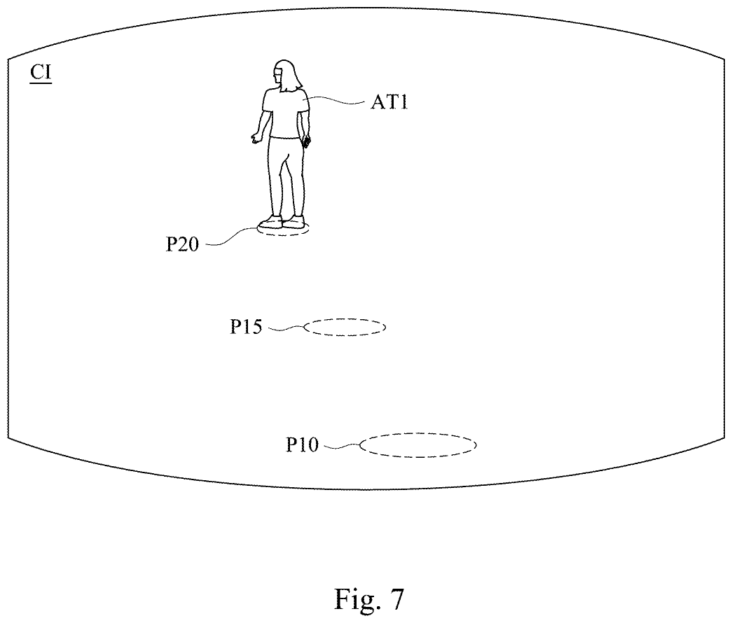

In operation S305, the processor 110 determines a movement mode of the avatar AT1 according to the first target pose PT1. In some embodiments, when the first target pose PT1 made by the user U1 is the static moving pose, the processor 110 sets the movement mode of the avatar AT1 to be a teleport mode. Also, when the first target pose PT1 made by the user U1 is the dynamic moving pose, the processor 110 sets the movement mode of the avatar AT1 to be a route mode different to the teleport mode. In particular, the teleport mode allows the avatar AT1 to move immediately to the destination without the influence of the distance between the avatar AT1 and the destination, and the route mode allows the avatar AT1 to be routed via at least one intermediate place (between the avatar AT1 and the destination) to the destination. The teleport mode and the route mode would be further described later with reference to FIG. 7.

In operation S306, the processor 110 generates a guide object O1 extending from the avatar AT1 along the facing direction F1 at a speed indicated by the speed parameter in the immersive content CI, which would be described with reference to FIG. 5. Referring to FIG. 5, FIG. 5 is a schematic diagram of the immersive content CI in accordance with some embodiments of the present disclosure. In some embodiments, as shown in FIG. 5, the avatar AT1 is currently at a position P10 in the immersive content CI. In this case, the processor 110 uses the position P10 as a starting point of the guide object O1, and extends the guide object O1 from the position P10 with a parabolic trajectory at the speed indicated by the speed parameter. In some further embodiments, an extending direction of the guide object O1 includes a horizontal component substantially parallel to the facing direction F1 and a vertical component. It should be understood that the processor 110 may generate the guide object O1 in the immersive content CI by controlling the display 210 in FIG. 2.

In addition, the speed indicated by the speed parameter (i.e., “+2”) corresponding to the whole-body moving pose is higher than the speed indicated by the speed parameter (i.e., “+1”) corresponding to the half-body moving pose. In other word, the extension of the guide object O1 when the user U1 makes the whole-body moving pose is faster than the extension of the guide object O1 when the user U1 makes the half-body moving pose.

As can be seen from the descriptions of operation S306, in some embodiments, when the user U1 makes the first target pose PT1, the avatar control system 100 displays the guide object O1 in the immersive content CI according to the facing direction F1 of the user U1 and the speed parameter. However, the present disclosure is not limited herein. In some embodiments, the speed that the guide object O1 is extended at is preset and fixed, and operation S303 may be omitted. In this case, when the user U1 makes the first target pose PT1, the avatar control system 100 displays the guide object O1 in the immersive content CI according to the facing direction F1 of the user U1.

In the field of view of the user U1 wearing the wearable device 200, after the user U1 makes the first target pose PT1, the avatar AT1 stays at the position P10, and the guide object O1 starts to extends from the avatar AT1 along the direction in which the user U1 is facing.

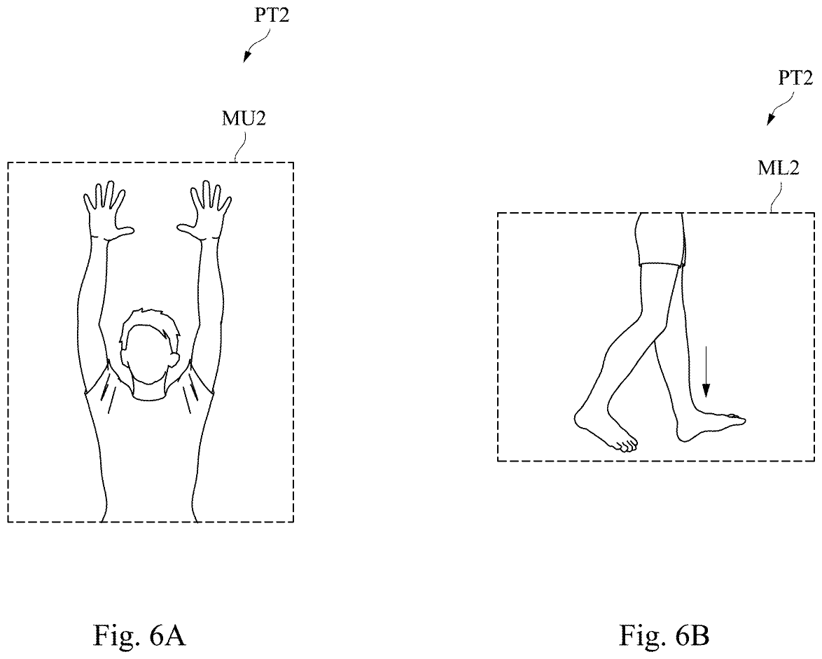

In operation S307, as shown in FIG. 3B, the processor 110 detects if the user U1 makes a second target pose PT2. In some embodiments, the processor 110 detects if the user U1 makes the second target pose PT2 by recognizing at least one of the upper body movement M2 and the lower body movement M3 (i.e., based on the sense data DS generated by the sensor 120), which is similar to operation S301 and operation S302. Referring to FIGS. 6A and 6B, FIGS. 6A and 6B are schematic diagrams of the second target pose PT2 in accordance with some embodiments of the present disclosure.

In some embodiments of operation S307, the processor 110 recognizes that the upper body movement M2 of the user U1 is substantially the same as another preset upper body movement MU2 as shown in FIG. 6A. In this case, the processor 110 determines that the user U1 makes the second target pose PT2. In particular, the preset upper body movement MU2 may be defined by some arm characteristics such as, two arms being raising upwards and perpendicular to the ground (as shown in FIG. 6A), two arms being raising forward and parallel to the ground, etc. Furthermore, the preset upper body movement MU2 may be static.

In some embodiments of operation S307, the processor 110 recognizes that the lower body movement M3 of the user U1 is substantially the same as a preset lower body movement ML2 as shown in FIG. 6B. In this case, the processor 110 determines that the user U1 makes the second target pose PT2. In particular, the preset lower body movement ML2 may be defined by some leg characteristics such as, the leg being lifting before is put down in the direction indicated by an arrow in FIG. 6B (i.e., none of the legs are lifting), one foot contacting the ground only with the heel, etc. Furthermore, the preset lower body movement ML2 may be static.

In the embodiments of FIG. 3B, when the processor 110 detects that the user U1 makes the second target pose PT2, operation S308 and operation S310 are executed.

In operation S308, as shown in FIG. 5, the processor 110 fixes a distal end ED of the guide object O1 at a position P20 in the immersive content CI. In other words, the processor 110 stops extending the guide object O1.

As can be seen from the descriptions of operation S306, operation S307 and operation S308, the extension of the guide object O1 is started at the time when the processor 110 detects that the user U1 makes the first target pose PT1, and is ended at the time when the processor 110 detects that the user U1 makes the second target pose PT2. The position P20 in the immersive content CI may be regarded as the aforementioned destination to which the avatar AT1 will be moved or routed.

Referring to FIG. 7, FIG. 7 is a schematic diagram of the immersive content CI in accordance with some embodiments of the present disclosure. In operation S310, as shown in FIG. 7, the processor 110 moves the avatar AT1 to the position P20 in the movement mode. As should be understood, by controlling the display 210 in FIG. 2, the processor 110 may fix the distal end ED of the guide object O1 at the position P20, and may move the avatar AT1 to the position P20.

In some embodiment, the movement mode is determined to be the teleport mode in operation S305. In this case, the processor 110 teleport the avatar AT1 immediately from the position P10 to the position P20. When the processor 110 moves the avatar AT1 in the teleport mode, the user U1 wearing the wearable device 200 would see that the avatar AT1 disappears from the position P10, and suddenly appears at the position P20.

Also, in some embodiment, the movement mode is determined to be the route mode in operation S305. In this case, the processor 110 moves the avatar AT1 from the position P10 to an intermediate position P15 (between the position P10 and the position P20), and then moves the avatar AT1 from the intermediate position P15 to the position P20. When the processor 110 moves the avatar AT1 in the route mode, the user U1 wearing the wearable device 200 would see that the avatar AT1 walks (or runs) from the position P10, through the intermediate position P15, and to the position P20.

As can be seen from the descriptions of operation S308 and operation S310, in some embodiments, when the user U1 makes the second target pose PT2, the processor 110 controls the avatar AT1 to appear at the position P20 indicated by the guide object O1 by controlling the display 210 in FIG. 2.

In the embodiments of FIG. 3B, when the processor 110 detects that the user U1 does not make the second target pose PT2, operation S309 is executed. In operation S309, the processor 110 stops displaying the guide object O1 in the immersive content CI. In some embodiments, the processor 110 controls the display 210 in FIG. 2 to remove the guide object O1 from the immersive content CI. In this case, the user U1 wearing the wearable device 200 would see that the avatar AT1 stays at the position P10, and the guide object O1 disappears from the immersive content CI.

In some further embodiments, when the processor 110 detects that the user U1 does not make the second target pose PT2, the processor 110 further detects if the guide object O1 being extended arrives the boarder of the immersive content CI. When the guide object O1 being extended arrives the boarder of the immersive content CI, the processor 110 removes the guide object O1 from the immersive content CI by controlling the display 210 (i.e., operation S309). In some further embodiments, the processor 110 is configured to start timing after the guide object O1 is generated in the immersive content CI. Then, when the processor 110 detects that the user U1 does not make the second target pose PT2 within a preset time, operation S309 is executed. In other words, if the user U1 wants to move the avatar AT1, the user U1 is required to make the second target pose PT2 within the preset time after the guide object O1 is generated in the immersive content CI. In such arrangements, the situation that the guide object O1 disappears before the user U1 makes the second target pose PT2 can be avoided.

In some further embodiments, the processor 110 can also remove the guide object O1 from the immersive content CI when detecting that the avatar AT1 is at the position P20 indicated by the guide object O1.

As can be seen from the descriptions of the avatar control method 300, the avatar control system 100 can be aware that the user U1 has the intension of moving or teleporting the avatar AT1 in the immersive content CI by detecting that the user U1 makes the first target pose PT1. When detecting that the user U1 makes the first target pose PT1, the avatar control system 100 can generate and extend the guide object O1 in the immersive content CI, by which the user U1 is allowed to choose the destination for the avatar AT1. The avatar control system 100 can be aware of the destination (i.e., the position P20) of the avatar AT1 in the immersive content CI by detecting that the user U1 makes the second target pose PT2. When detecting that the user U1 makes the second target pose PT2, the avatar control system 100 can control the avatar AT1 to appear at the aforementioned destination.

Generally, when the user U1 wants to move forward in the real-world environment, a first instinct of the user U1 may be to make certain body movement such as, at least one of the legs moving forward, at least one of the arms swing forward, body leaning forward, etc. The avatar control system 100 and the avatar control method 300 allows the user U1 to intuitively control the avatar AT1 by sequentially making the first target pose PT1 and the second target pose PT2 with the upper body and/or the lower body. In sum, the avatar control system 100 and the avatar control method 300 may provide the user U1 advantages of intuitive operability, well immersion, well gameplay experience, etc.

The disclosed methods, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the at least one processor to provide a unique apparatus that operates analogously to application specific logic circuits.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the invention. In view of the foregoing, it is intended that the present invention cover modifications and variations of this invention provided they fall within the scope of the following claims.

What is claimed is:

1. An avatar control method, applicable to an avatar control system, configured to control an avatar, which is corresponding to a user in a real-world environment, in an immersive content, and comprising:
detecting if the user makes a first target pose;
when the user makes the first target pose, displaying a guide object in the immersive content according to a facing direction of the user;
detecting if the user makes a second target pose different from the first target pose; and
when the user makes the second target pose, controlling the avatar to appear at a position indicated by the guide object.

2. The avatar control method of claim 1, further comprising:
when the user makes the first target pose, determining a movement mode of the avatar according to the first target pose, wherein the avatar is controlled to appear at the position according to the movement mode.

3. The avatar control method of claim 2, wherein determining the movement mode of the avatar according to the first target pose comprises:
when the first target pose is a static moving pose, setting the movement mode of the avatar to be a teleport mode; and
when the first target pose is a dynamic moving pose, setting the movement mode of the avatar to be a route mode.

4. The avatar control method of claim 1, wherein controlling the avatar to appear at the position comprises:
fixing a distal end of the guide object at the position in the immersive content; and
moving the avatar to the position in a movement mode determined according to the first target pose.

5. The avatar control method of claim 4, wherein moving the avatar to the position in the movement mode comprises:
when the movement mode is a teleport mode, teleporting the avatar immediately from a current position where the avatar currently is to the position indicated by the guide object; and
when the movement mode is a route mode, moving the avatar from the current position to an intermediate position, and then moving the avatar from the intermediate position to the position indicated by the guide object, wherein the intermediate position is between the current position and the position indicated by the guide object.

6. The avatar control method of claim 1, wherein displaying the guide object in the immersive content according to the facing direction comprising:
generating the guide object extending from the avatar along the facing direction.

7. The avatar control method of claim 1, further comprising:
setting a speed parameter according to the first target pose, wherein the speed parameter is configured to indicate a speed at which the guide object is extended.

8. The avatar control method of claim 1, further comprising:
obtaining the facing direction according to a head movement of the user, wherein the guide object extends along the facing direction.

9. The avatar control method of claim 1, wherein detecting if the user makes the first target pose comprises:
recognizing at least one of an upper body movement and a lower body movement of the user.

10. The avatar control method of claim 1, further comprising:
when the user does not make the second target pose within a preset time, stopping displaying the guide object in the immersive content.

11. An avatar control system, configured to control an avatar, which is corresponding to a user in a real-world environment, in an immersive content, and comprising:
a sensor, configured to generate sense data; and
a processor, coupled to the sensor, and configured to:
detect if the user makes a first target pose based on the sense data;
when the user makes the first target pose, display a guide object in the immersive content according to a facing direction of the user by controlling a display;
detect if the user makes a second target pose different from the first target pose based on the sense data; and
when the user makes the second target pose, control the avatar to appear at a position indicated by the guide object by controlling the display.

12. The avatar control system of claim 11, wherein the processor is further configured to:
determine a movement mode of the avatar according to the first target pose when the user makes the first target pose, wherein the avatar is controlled to appear at the position according to the movement mode.

13. The avatar control system of claim 12, wherein the processor is configured to:
when the first target pose is a static moving pose, set the movement mode of the avatar to be a teleport mode; and
when the first target pose is a dynamic moving pose, set the movement mode of the avatar to be a route mode.

14. The avatar control system of claim 11, wherein the processor is configured to:
fix a distal end of the guide object at the position in the immersive content; and
move the avatar to the position in a movement mode determined according to the first target pose.

15. The avatar control system of claim 14, wherein the processor is configured to:
when the movement mode is a teleport mode, teleport the avatar immediately from a current position where the avatar currently is to the position indicated by the guide object; and
when the movement mode is a route mode, move the avatar from the current position to an intermediate position, and then move the avatar from the intermediate position to the position indicated by the guide object, wherein the intermediate position is between the current position and the position indicated by the guide object.

16. The avatar control system of claim 11, wherein the processor is configured to:
generate the guide object extending from the avatar along the facing direction.

17. The avatar control system of claim 11, wherein the processor is further configured to:
set a speed parameter according to the first target pose, wherein the speed parameter is configured to indicate a speed at which the guide object is extended.

18. The avatar control system of claim 11, wherein the processor is further configured to:
obtain the facing direction according to a head movement of the user, wherein the guide object extends along the facing direction.

19. The avatar control system of claim 11, wherein the processor is configured to:
recognize at least one of an upper body movement and a lower body movement of the user, to detect if the user makes the first target pose.

20. A non-transitory computer readable storage medium with a computer program to execute an avatar control method, wherein the avatar control method is applicable to an avatar control system, is configured to control an avatar, which is corresponding to a user in a real-world environment, in an immersive content, and comprises:
detecting if the user makes a first target pose;
when the user makes the first target pose, displaying a guide object in the immersive content according to a facing direction of the user;
detecting if the user makes a second target pose different from the first target pose; and
when the user makes the second target pose, controlling the avatar to appear at a position indicated by the guide object.
